(19) United States
(12) Patent Application Publication
(10) Pub. No.: US 2017/0114581 A1
(43) Pub. Date: Apr. 27, 2017

(54) DOOR HINGE

(71) Applicant: HSCC Ltd., Wanchai (CN)

(72) Inventor: Juergen Jeanrot, Guangdong (CN)

(21) Appl. No.: 15/297,349

(22) Filed: Oct. 19, 2016

Related U.S. Application Data
(60) Provisional application No. 62/245,380, filed on Oct. 23, 2015.

(51) Int. Cl. E05F 5/02; E05D 11/10; E05D 3/02

(52) U.S. Cl. CPC E05F 5/027; E05D 3/022; E05D 11/10; E05D 2700/04; E05Y 2900/114

(57) ABSTRACT

A door hinge comprises a hinge axis (R), a first armature part for attachment to a door, a second armature part for attachment to a wall, pivotably coupled with the first armature part, a rotational bearing having a first bearing part coupled to the first armature part and a second bearing part coupled to the second armature part, the rotational bearing comprising at least one surface for lifting the first armature part relative to the second armature part upon rotating the second armature part from a closed to an open position, and a hydraulic dampener integrated into the rotational bearing for dampening the lowering movement of the second armature part when pivoting the hinge in a closed position.

### BACKGROUND OF THE INVENTION

The term door relates to all elements featuring hinges which can be used to close an opening, e.g. doors, flaps, hatches, etc.

Door hinges are well known. Apart from very basic designs, there are a variety of more sophisticated door hinges that feature additional functions. One such feature is a door that is lifted when the door is swiveled opened around its hinge and closes autonomously due to its weight.

The disadvantage of current designs is that these kind of doors shut very abruptly due to their weight, which results in high stress on the door and bears the risk of injury.

The object of the present invention is to provide a door hinge that dampens the force with which the door slams shut, in this way softening the closing of the door.

### SUMMARY OF THE INVENTION

To achieve this object, the invention provides a door hinge, comprising a hinge axis, a first armature part for attachment to a door, a second armature part for attachment to a wall, pivotably coupled with the first armature part, a rotational bearing having a first bearing part coupled to the first armature part and a second bearing part coupled to the second armature part, the rotational bearing comprising at least one surface for lifting the first armature part relative to the second armature part upon rotating the second armature part from a closed to an open position, and a hydraulic dampener integrated into the rotational bearing for dampening the lowering movement of the second armature part when pivoting the hinge into a closed position.

According to an embodiment, the at least one surface for lifting the first armature part relative to the second armature part is a cam surface protruding from a radial plane extending perpendicular to the hinge axis.

According to a further embodiment, the at least one cam surface is a front surface of the first and/or second bearing part, in particular wherein the first and the second bearing parts have front surfaces opposing each other, at least one of the front surfaces defining the cam surface.

Preferably, the at least one cam surface has a wave-shaped design, in particular wherein the shapes of the cam surfaces are complementary to each other at least in sections.

According to a preferred further embodiment, the at least one surface for lifting the first armature part relative to the second armature part comprises a thread, in particular wherein the first bearing part has a female thread and the second bearing part has a corresponding male thread.

The dampener may have an elongated, preassembled piston-cylinder unit with a piston rod end protruding from the cylinder.

The dampener can be arranged within the bearing parts.

According to a further embodiment, the dampener is arranged coaxially to the hinge axis.

Preferably at least one of the bearing parts comprises a sleeve portion, the dampener being arranged within the interior of the sleeve portion.

The upper one of the bearing parts has a first front wall against which the dampener abuts, in particular wherein the first front wall is a separate plug attached to the bearing part, especially screwed into the bearing part.

The bearing parts can be arranged in reception holes in the armature parts, in particular wherein the dampener extends into at least one reception hole and abuts against a second front wall in the reception hole which can be a separate plug attached to the corresponding armature part.

The invention also provides a door hinge, comprising a hinge axis, a first armature part for attachment to a door, a second armature part associated for attachment to a wall, pivotably coupled with the first armature part, a rotational bearing comprising a bearing rod fixedly coupled with one of the first and the second armature parts and rotatably received in a bearing part at the other of the first and second armature parts, the rod having a non-circular cylindrical circumferential surface defining a cam having portions with different distances from the hinge axis, at least one hydraulic dampener being attached to the other of the first and the second armature parts, the hydraulic dampener having a longitudinal axis extending radially to the longitudinal hinge axis of the rod and urging against the cam, in particular wherein the cam has a radially most outward portion assigned to the closed position of the hinge.

According to a preferred further embodiment, the dampener comprises an elongated, preassembled piston-cylinder unit with a piston rod end protruding from the cylinder, and a spring through which the rod extends and a head part attached to the outer free end of the rod, the spring extending between the head part and the cylinder and being arranged to pull the dampener in an extended position.

Preferably, at least two dampeners are arranged parallel to each other and urge against the cam.

At least one dampener can be housed in the other of the first and the second armature parts.

Features and advantages of the invention will become apparent or be discussed in the following detailed description.

### BRIEF DESCRIPTION OF THE DRAWINGS

FIG. 1 is a side view of a hinge bearing unit for a door hinge according to a first embodiment of the invention;

FIG. 2 is an exploded view of the hinge bearing unit of FIG. 1;

FIG. 3a) is a sectional view of a door and a door hinge according to the invention with a hinge bearing unit according to FIG. 1 in a closed position;

FIG. 3b) is a top view of the door hinge of FIG. 3a) in the closed position;

FIG. 4a) is a sectional view of a door and a door hinge with a hinge bearing unit according to FIG. 1 in a 90° open position;

FIG. 4b) is a top view of the door hinge of FIG. 4a) in the 90° open position;

FIG. 5 is an exploded view of a hinge bearing unit for a door hinge according to a second embodiment of the invention;

FIG. 6a) is a sectional view of a door hinge with a hinge bearing unit according to FIG. 5 in a closed position;

FIG. 6b) is a top view of the door hinge of FIG. 6a) in the closed position;

FIG. 7a) is a sectional view of the door hinge with a hinge bearing unit according to FIG. 5 in a 90° open position;

FIG. 7b) is a top view of the door hinge of FIG. 7a) in the 90° open position;

FIG. 8a) is a sectional view of a hinge bearing unit for a door hinge according to a third embodiment of the invention;

FIG. 8b) is an exploded view of the hinge bearing unit of FIG. 8a) in a closed position;

FIG. 8c) is an exploded view of the hinge bearing unit of FIG. 8a) in an open position;

FIG. 9a) is a sectional view of a hinge bearing unit for a door hinge according to a forth embodiment of the invention;

FIG. 9b) is an exploded view of the hinge bearing unit of FIG. 9a) in a closed position; and

FIG. 9c) is an exploded view of the hinge bearing unit of FIG. 9a) in an open position;

### DETAILED DESCRIPTION OF THE INVENTION

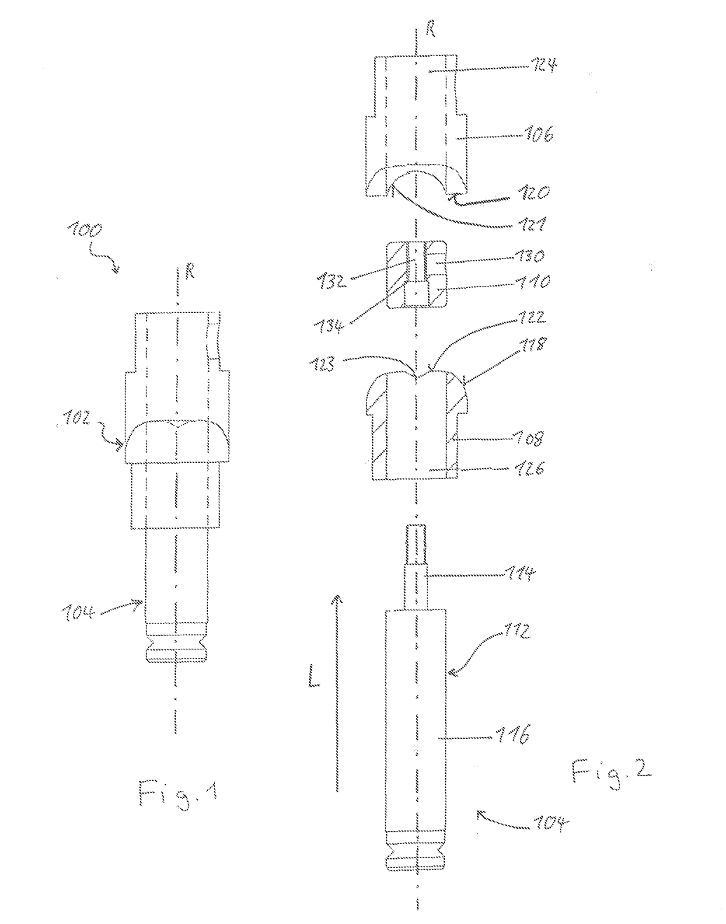

In FIG. 1 and 2, a hinge bearing unit 100 according to a first embodiment of the invention is shown. The hinge bearing unit 100 comprises a rotational bearing 102 and a hydraulic dampener 104 which are arranged coaxially to the hinge axis R.

The rotational bearing 102 comprises a first, upper bearing part 106, a second, lower bearing part 108 which both comprise a sleeve portion, and a plug 110 which defines a first front wall closing bearing part 106.

The hydraulic dampener 104 has an elongated, preassembled piston-cylinder unit 112 with a piston rod end 114 which protrudes from the cylinder 116 and is resiliently pushed in direction L by the pressure within the cylinder 116.

The first bearing part 106 and the second bearing part 108 feature front surfaces 118, 120 (here: ring-shaped front surfaces) which are opposing each other and are, at least in sections, complementary as well as contacting each other.

In this embodiment, each of the front surfaces 118, 120 defines a cam surface 121, 122 which each has a wave-shaped design and protrudes from a virtual radial plane extending perpendicular to the hinge axis R. The cam surfaces 121, 122 result in the bearing parts 106, 108 being pushed apart when the bearing parts 106, 108 are rotated against each other around the hinge axis R by a set angle from a closed into an open position.

The second bearing part 108 comprises an indentation 123 at its front surface 118 that is used to predefine a preferred relative position (closed position of the hinge) of bearing parts 106, 108.

Each bearing part 106, 108 features a through-hole 124, 126 which is arranged coaxially to the hinge axis R. The through-hole 124 of the first bearing part 106 is at least as wide as the plug 110 while the through-hole 126 of the second bearing part 108 is at least as wide as the cylinder 116 of the piston-cylinder unit 112. The through-hole 124, 126 in which the hydraulic dampener 104 is arranged leads to bearing parts 106, 108 in the form of sleeves.

The plug 110 is cylindrical in shape and positioned within the through-hole 124 of the first bearing part 106. It comprises a side bore 130 for a grub screw and an axial seat 132 for the piston rod end 114 of the hydraulic dampener 104.

The seat 132 has a first front wall 134 against which the hydraulic dampener 104 abuts. The dampener has a thread end which is screwed into a female thread in the seat 132.

In an alternative embodiment the plug 110 does not exist as a separate component and its function is fulfilled by the bearing parts 106, 108 for example.

In a further alternative embodiment the first front wall 134 can also be part of the bearing parts 106, 108 or be implemented as a separate plug that is attached to the bearing part 106, 108, e.g. screwed into the bearing part 106, 108.

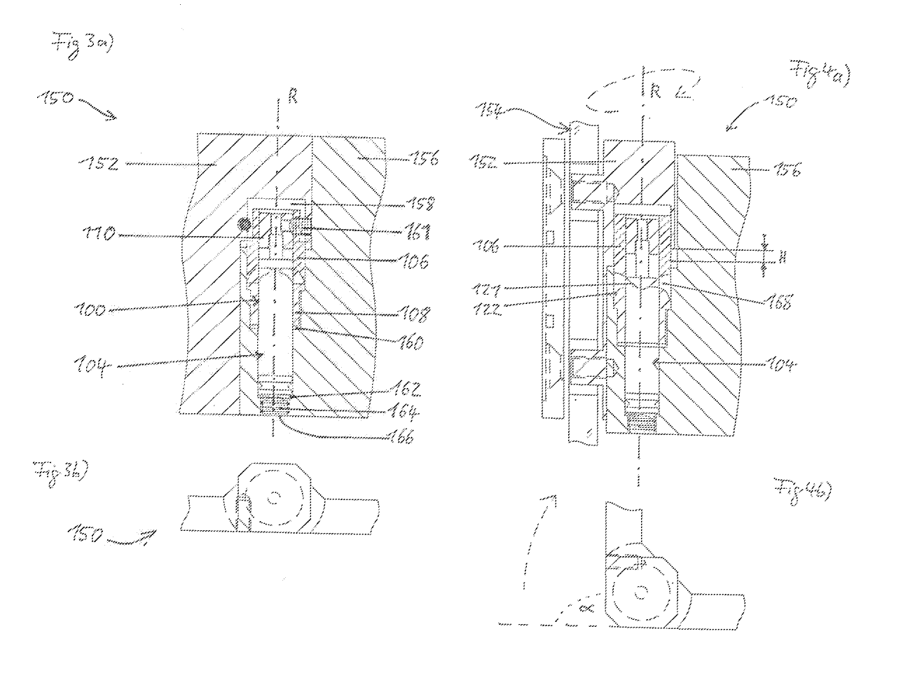

FIGS. 3a) and 3b) illustrate how the hinge bearing unit 100 is installed in a door hinge 150 of a door in a closed position.

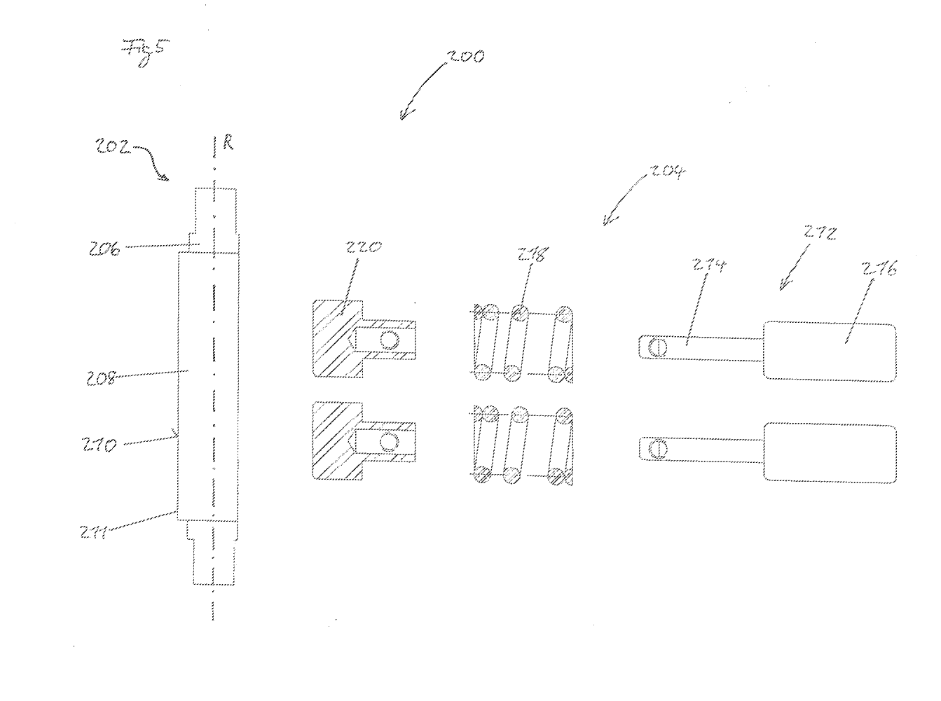

The door hinge 150 comprises a first armature part 152 that is attached to a door 154 (see FIG. 4a) and a second armature part 156 that is attached to a wall and is pivotably coupled with the first armature part 152 by the hinge bearing unit 100.

The door 154 can be part of a shower cabinet but the invention is not limited to this application and can be used in a variety of doors, flaps and hatches.

The wall defines a non-rotational part to which the door 154 is attached by means of the door hinge 150.

The bearing parts 106, 108 are arranged in reception holes 158, 160 in the armature parts with the first bearing part 106 being coupled to the first armature part 152 by a grub screw 161 that also fixes the plug 110 in place while the second bearing part 108 being coupled to the second armature part 156.

By the first bearing part 106 extending into reception hole 160 of the second armature part 156, a pivot pin of the hinge is generated to couple door and wall.

The hydraulic dampener 104 extends out of the second bearing part 108 into the lower end portion of the reception hole 160 and abuts against a second front wall 162.

A second plug 164 is attached to the second armature part 156 and seals an opening 166 in the second armature part 156.

In an alternative embodiment the second plug 164 could be used as the second front wall 162.

FIGS. 4a) and 4b) show the door 154 of FIGS. 3a) and 3b) in an open position where the angle α of the first armature part 152 to the second armature part 156 is 90°.

The cam surfaces 121, 122 cause a gap 168 between the bearing parts 106, 108 when the door 154 is opened. This rotation of the second armature part 156 from a closed to an open position results in the first armature part 152 being lifted by a distance H relative to the second armature part 156.

When the door hinge 150 pivots in a closed position again, the hydraulic dampener 104 dampens the lowering movement of the second armature part 156 thereby preventing the door 154 from slamming shut.

FIG. 5 illustrates a second embodiment of the present invention, wherein the hinge bearing unit 200 comprises a rotational bearing 202 and at least one (here two) hydraulic dampener 212 which is arranged perpendicular to the hinge axis R.

The rotational bearing 202 is formed by a bearing rod 206 which features a section 208 with a non-circular cylindrical circumferential surface 210 defining a cam 211 having portions with different distances from the hinge axis R.

The hydraulic dampeners 212 are two identical units which are arranged parallel to each other. Each unit comprises an elongated, preassembled piston-cylinder unit 212 with a piston rod end 214 which protrudes from a cylinder 216. A spring 218 through which the piston rod end 214 extends and a head part 220 attached to the outer free piston rod end 214 are for urging against the cam 211 in order to self-close the door by the force of the springs.

The spring 218 extends between the head part 220 and the cylinder 216 and pulls the hydraulic dampener 204 in an extended position.

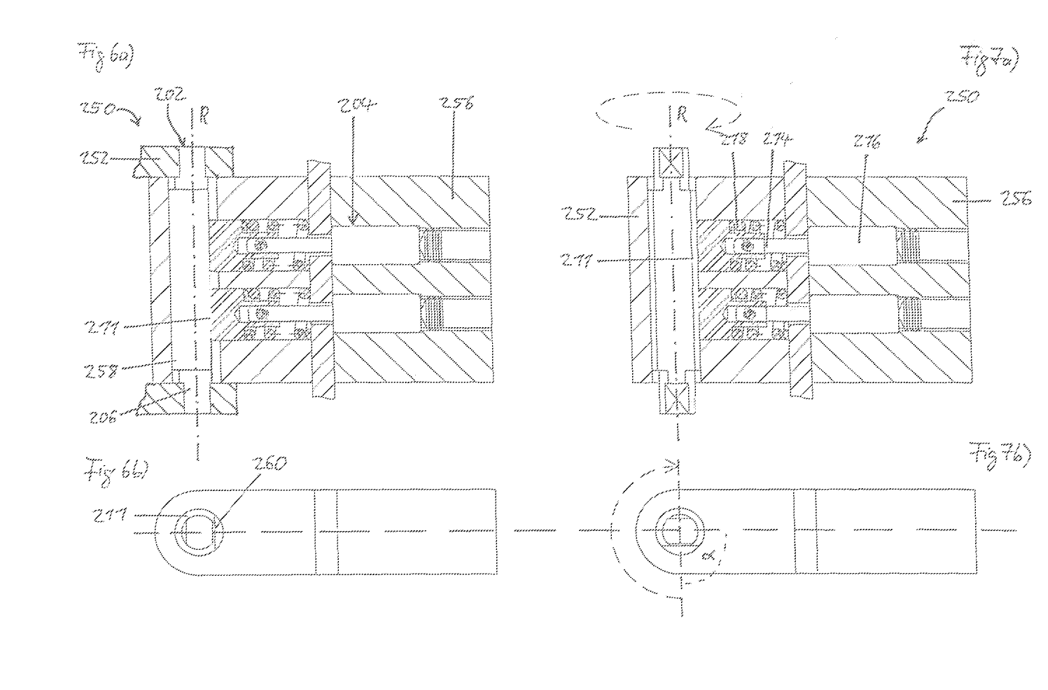

FIGS. 6a) and 6b) illustrate how the hinge bearing unit 200 is installed in a door hinge 250 of a door in a closed position.

The door hinge 250 comprises a first armature part 252 that is attached to a door and a second armature part 256 that is attached to a wall and is pivotably coupled with the first armature part 252 by the rotational bearing 202.

The bearing rod 206 is rotationally coupled with the second armature part 252 and rotatably received in the corresponding receiving hole which defines a bearing part at the second armature part 256.

At its axial ends protruding out from the receiving hole, rod 206 is fixedly secured to the door armature 252 so that swiveling of the door leads to a rotation of rod 206.

The door hinge 250 also comprises the parallel hydraulic dampeners 204 which are attached to and embedded in the second armature part 256.

In this embodiment the hydraulic dampeners 204 extend perpendicular to the longitudinal hinge axis R of the bearing rod 206 and urges against the cam 211.

The cam 211 has a radially most outward portion 258 assigned to the opened position of the door hinge 250 close to which dampeners 204 urge against the cam 211 in order to exert a closing force to the cam 211.

In the closed position the hydraulic dampener 204 urges against a flat section 260 of the cam 211 which section 260 does not extend radially as far outwards as other sections in its proximity.

FIGS. 7a) and 7b) show the door hinge 250 of FIGS. 6a) and 6b) in an open position where the angle α of the first armature part 252 to the second armature part 256 is 90°.

In this open position the cam 211 pushes the piston rod ends 214 into the cylinders 216 and further compresses the springs 218. The springs 218 try to rotate the rod 206 as the springs 218 urge against a part of the cam 211 which is eccentrically to a virtual line which extends radially from the rod towards the spring. Thus, a turning moment is generated onto the rod 206 leading to a self-closing action of the door.

When the door hinge 250 pivots in a closed position again, the hydraulic dampener 204 dampens the closing movement of the door by pressing against the cam 211 of the bearing rod 206.

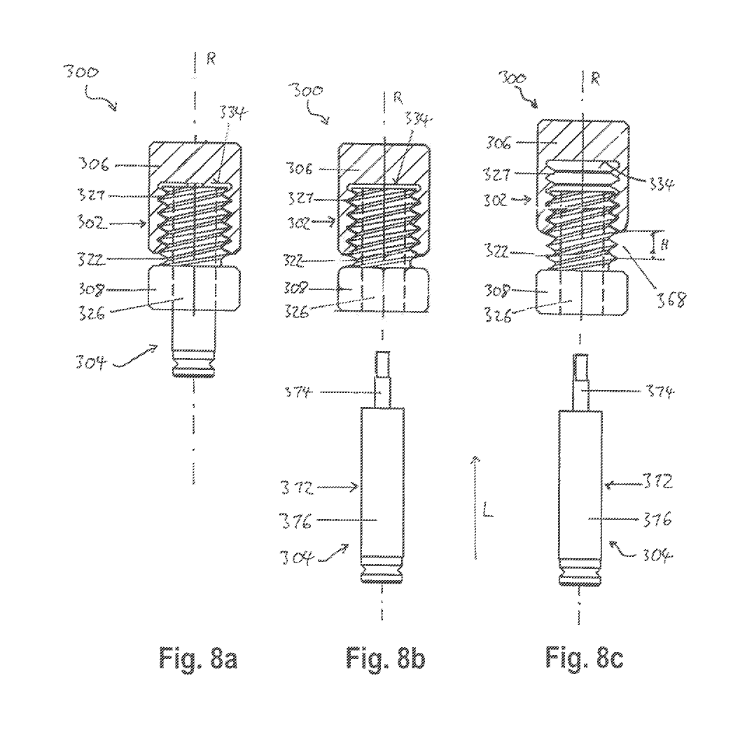

FIG. 8a) illustrates a third embodiment of the present invention, wherein the hinge bearing unit 300 comprises a rotational bearing 302 and a hydraulic dampener 304 which are arranged coaxially to the hinge axis R.

The rotational bearing 302 comprises a first, upper bearing part 306 and a second, lower bearing part 308 which comprises a sleeve portion.

The hydraulic dampener 304 has an elongated, preassembled piston-cylinder unit 312 with a piston rod end 314 which protrudes from the cylinder 316 and is resiliently pushed in direction L by the pressure within the cylinder 316 (see FIG. 8b).

The first bearing part 306 features a section with a surface 318 in the form of a female thread 321 aligned with the hinge axis R and the second bearing part 308 features a section with a surface 320 in the form of a corresponding male thread 322, so that the first bearing part 306 and the second bearing part 308 are coupled to each in the direction of the hinge axis R by the threads 321, 322.

The threads 321, 322 result in the bearing parts 306, 308 being pushed apart when the bearing parts 306, 308 are rotated against each other around the hinge axis R by a set angle from a closed position (see FIG. 8b) into an open position (see FIG. 8c).

The second bearing part 308 features a through-hole 326 which is arranged coaxially to the hinge axis R. The through-hole 326 is at least as wide as the cylinder 316 of the piston-cylinder unit 312.

The first bearing part 306 has a front wall 334 against which the piston rod end 314 of the hydraulic dampener 304 abuts.

The hinge bearing unit 300 is designed to be used in a door hinge comprising a first armature part that is attached to a door and a second armature part that is attached to a wall in the same way as hinge bearing unit 100.

The threads 321, 322 cause a gap 368 between the bearing parts 306, 308 when the door is opened. This rotation of the second armature part from a closed (see FIG. 8b) to an open position (see FIG. 8c), results in the first armature part being lifted by a distance H relative to the second armature part.

When the door hinge pivots in a closed position again, the hydraulic dampener 304 dampens the lowering movement of the second armature part thereby preventing the door from slamming shut.

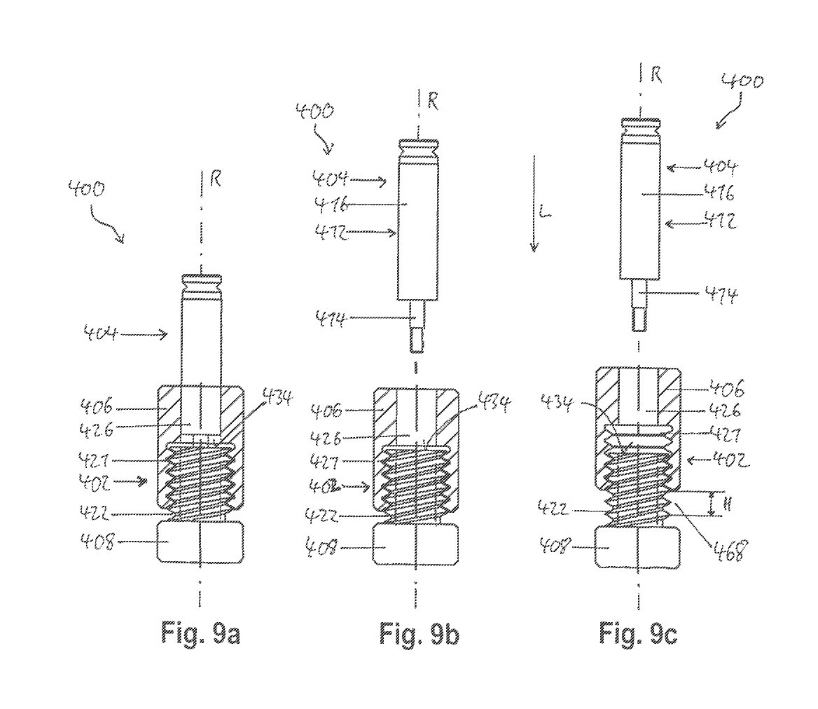

FIGS. 9a) to 9c) illustrate a forth embodiment of the present invention that is a variant of the third embodiment of the present invention shown in FIGS. 8a) to 8c).

Just like the hinge bearing unit 300 the hinge bearing unit 400 has a rotational bearing 402 comprising a first, upper bearing part 406 and a second, lower bearing part 408 as well as a hydraulic dampener 404 which are arranged coaxially to the hinge axis R.

In this embodiment though, the first bearing part 406 features a through hole 426 to accommodate the hydraulic dampener 404 and the second bearing part 408 features a front wall 434 against which the piston rod end 414 of the hydraulic dampener 404 abuts.

In this way the roles of the first and the second bearing part 406, 408 are reversed and the orientation of the hydraulic dampener 404 is turned by 180° in regard to the third embodiment. All other features as well as the function of the third embodiment are retained in the forth embodiment and are referenced by respective reference numerals.

In the following, aspects of hinges according to the invention are presented which are part of the present invention:
The hinges can be surface mounted and/or concealed mounted. They can be mounted to the floor, the ceiling, a transom or overhead. They can be bottom, top and/or side hinges.

The hinges can be mounted to the door, sideline, door jamb or door frame as well as frameless.

The mount of the hinges can be offset and/or center.

The doors comprising hinges according to the invention can be single action, i.e. one way opening, or double action, i.e. two ways opening.

The doors comprising hinges according to the invention can comprise opening angles up to 360 degrees.

The door hinge mechanism comprises three main parts: the rising mechanism in the form of a cam surface or thread, an axle that provides a rotational pivot point and a dampener in the form of a hydraulic dampener.

It is also possible to design the mechanism in two main parts comprising only the rising mechanism and the dampener. In that case the dampener shaft or body or housing is used as axle.

One part or side of the rising mechanism can also be grouped with the dampener or the axle.

The door hinge, in particular these three or two main components, can be made from any materials.

The rising mechanism, the axle and the dampener can be designed as a single part, as two groups of parts or as three or more groups of parts.

The rising mechanism, the axle and the dampener can be located into a single component of the door, e.g. hinge or pivot.

The rising mechanism, the axle and the dampener can be split and be located in two or more different components of the door, e.g. hinge or pivot.

For example, a door can include three hinges, the first hinge incorporating the rising mechanism, the second hinge incorporating the axle and the third hinge incorporating the dampener. In a second example, two door hinges include the axle and the rising mechanism while the damper is floor or ceiling mounted.

The rising mechanism can be designed in various different ways, including: V shaped male and female parts in particular bottom and top V shapes, an O shaped male part with a U shaped female part or V shaped male parts with a horizontal O shaped axle resting in the V.

The three or two main parts, i.e. rising mechanism, axle and dampener, can be located in the same or different vertical positions as well as in the same or different horizontal planes.

The dampener motion can be vertical and/or horizontal and/or rotational.

The motion can arise from the complete dampener assembly, i.e. body, housing and shaft are moving, or only of some parts that contribute to the motion.

Compression of the dampener can be inward or outward.

The rising mechanism can be vertically reversible.

The dampener can be linked between the two parts of the hinge or pivot.

The dampener can be linked to one side of the hinge only, e.g. rising up by itself while the hinge is opening.

In addition, any modifications and/or variants that are obvious to a person skilled also fall under the scope of the present invention.

1. A door hinge, comprising
a hinge axis,
a first armature part for attachment to a door,
a second armature part for attachment to a wall, pivotably coupled with the first armature part,
a rotational bearing having a first bearing part coupled to the first armature part and a second bearing part coupled to the second armature part,
the rotational bearing comprising at least one surface for lifting the first armature part relative to the second armature part upon rotating the second armature part from a closed to an open position, and
a hydraulic dampener integrated into the rotational bearing for dampening the lowering movement of the second armature part when pivoting the hinge in a closed position.

2. The door hinge according to claim 1, wherein the at least one surface for lifting the first armature part relative to the second armature part is a cam surface protruding from a radial plane extending perpendicular to the hinge axis.

3. The door hinge according to claim 2, wherein the cam surface is a front surface of the first and/or second bearing part

4. The door hinge according to claim 3, wherein the first and the second bearing parts have front surfaces opposing each other, at least one or both front surfaces defining a cam surface.

5. The door hinge according to claim 2, wherein the at least one surface that is a cam surface has a wave-shaped design.

6. The door hinge according to claim 5, wherein the shapes of the cam surfaces are complementary to each other at least in sections.

7. The door hinge according to claim 1, wherein the at least one surface for lifting the first armature part relative to the second armature part comprises a thread.

8. The door hinge according to claim 1, wherein the dampener has an elongated, preassembled piston-cylinder unit with a piston rod end protruding from the cylinder.

9. The door hinge according to claim 1, wherein the dampener is arranged within the bearing parts.

10. The door hinge according to claim 1, wherein the dampener is arranged coaxially to the hinge axis.

11. The door hinge according to claim 1, wherein at least one of the bearing parts comprises a sleeve portion, the dampener being arranged within the interior of the sleeve portion.

12. The door hinge according to claim 1, wherein an upper one bearing part has a first front wall against which the dampener abuts.

13. The door hinge according to claim 12, wherein the first front wall is a separate plug attached to the bearing part.

14. The door hinge according to claim 1, wherein the bearing parts are arranged in reception holes in the armature parts

15. The door hinge according to claim 14, wherein the dampener extends into at least one reception hole and abuts against a second front wall in the reception hole which can be a separate plug attached to the corresponding armature part.

16. A door hinge, comprising
a hinge axis,
a first armature part for attachment to a door,
a second armature part associated for attachment to a wall, pivotably coupled with the first armature part,
a rotational bearing comprising a bearing rod fixedly coupled with one of the first and the second armature parts and rotatably received in a bearing part at the other of the first and second armature parts,
the rod having a non-circular cylindrical circumferential surface defining a cam having portions with different distances from the hinge axis,
at least one hydraulic dampener being attached to the other of the first and the second armature parts, and
the hydraulic dampener having a longitudinal axis extending radially to the longitudinal hinge axis of the rod and urging against the cam.

17. The door hinge according to claim 16, wherein the cam has a radially most outward portion assigned to the closed position of the hinge.

18. The door hinge according to claim 16, wherein the dampener comprises an elongated, preassembled piston-cylinder unit with a piston rod end protruding from the cylinder, and
a spring through which the rod extends and a head part attached to the outer free end of the rod, the spring extending between the head part and the cylinder and being arranged to pull the dampener in an extended position.

19. The door hinge according to claim 16, wherein at least two dampeners are arranged parallel to each other and urging against the cam.

20. The door hinge according to claim 16, wherein at least one dampener is housed in the other of the first and the second armature parts.
